(19) United States
(12) Patent Application Publication
(10) Pub. No.: US 2022/0010876 A1
(43) Pub. Date: Jan. 13, 2022

(54) METHOD AND CONTROL UNIT FOR SETTING A DRIVE STAGE OF A VEHICLE TRANSMISSION, AND SENSOR DEVICE FOR DETECTING A SELECTION OF A DRIVE STAGE OF A VEHICLE TRANSMISSION

(71) Applicant: ZF Friedrichshafen AG, Friedrichshafen (DE)

(72) Inventors: Lenard Petrzik, Diepholz (DE); Vitali Fribus, Quakenbrück (DE); Alex Hessel, Lemförde (DE)

(73) Assignee: ZF Friedrichshafen AG, Friedrichshafen (DE)

(21) Appl. No.: 17/294,073

(22) PCT Filed: Nov. 15, 2019
(86) PCT No.: PCT/EP2019/081443

§ 371 Date: May 14, 2021

(30) Foreign Application Priority Data
Nov. 15, 2018 (DE) 102018219544.7

(51) Int. Cl. F16H 59/08

(52) U.S. Cl. CPC F16H 59/08; F16H 61/18; B60K 2370/158

(57) ABSTRACT

A method for setting a drive stage in a vehicle transmission may include an input step and an output step. A first input signal, representing a first axial wiping movement over a first input region, is input in the input step. A second input signal, representing a second axial wiping movement over a second input region, parallel to the first axial wiping movement, is also input. The first wiping movement and the second wiping movement are at least partially simultaneous. A shifting signal for setting a selected drive stage is output in the output step, based on the first input signal and the second input signal. A first path of the first axial wiping movement and a second path of the second axial wiping movement determine the selected drive stage.

### RELATED APPLICATION

This application is a filing under 35 U.S.C. § 371 of International Patent Application PCT/EP2019/081443, filed Nov. 15, 2019, and claiming priority to German Patent Application 10 2018 219 544.7, filed Nov. 15, 2018. All applications listed in this paragraph are hereby incorporated by reference in their entireties.

### TECHNICAL FIELD

The present disclosure relates to a method and a control unit for setting a drive stage in a vehicle transmission and a sensor device for detecting a selection of a drive stage in a vehicle transmission. A computer program is also within the subject matter of the present disclosure.

### BACKGROUND

To actuate a transmission in a vehicle, it is possible to touch an image shown on a display that represents a drive stage and to guide the image along a selection path with a touch gesture within a tactile guide element to select the drive stage.

DE 102016200020 A1 describes an actuation device for an electronic transmission assembly in a motor vehicle that enables this selection of the drive stage.

### BRIEF DESCRIPTION OF THE DRAWINGS

Certain embodiments shall be explained in greater detail by way of example, in reference to the attached drawings. Therein:

FIG. 1 shows a schematic illustration of a control unit for setting a drive stage in a vehicle transmission, and a sensor device for detecting a selection of a drive stage in a vehicle transmission according to an exemplary embodiment, for use in a vehicle.

FIG. 2 shows a flow chart for a method for setting a drive stage in a vehicle transmission according to an exemplary embodiment.

FIGS. 3a to 3d each show a schematic illustration of drive stage assignments to input regions for setting a drive stage in a vehicle transmission, for use in an exemplary embodiment of the approach described herein.

FIGS. 4a to 4g each show a schematic illustration of drive stage assignments to input regions for setting a drive stage in a vehicle transmission, for use in an exemplary embodiment of the approach described herein.

FIGS. 5a to 5d each show a schematic illustration of drive stage assignments to input regions for setting a drive stage in a vehicle transmission, for use in an exemplary embodiment of the approach described herein.

### DETAILED DESCRIPTION

Based on the background discussed above, the present disclosure covers an improved method and an improved control unit for setting a drive stage in a vehicle transmission and an improved sensor device for detecting a selection of a drive stage in a vehicle transmission

As understood by the inventors, it is possible to select a drive stage for a vehicle transmission by wiping over two different parallel input regions at the same time. Two independently generated input signals, each representing one wiping movement can then be input, thus increasing input reliability. In addition, the selection of the drive stage is quick and can be implemented by simple wiping movements, which has advantages with regard to user friendliness.

A method for setting a drive stage in a vehicle transmission is presented herein. The method has at least one input step and one output step. In the input step, a first input signal is input, which represents a first axial wiping movement over a first input region. In addition, a second input signal that represents a second axial wiping movement over a second input region, parallel to the first axial wiping movement, is also input in the input step. The first and second wiping movements are at least partially simultaneous. In the output step, a shifting signal for setting the selected drive stage is output based on the first input signal and the second input signal. A first path of the first axial wiping movement and a second path of the second axial wiping movement then determine the selected drive stage.

The vehicle transmission can be an electronic transmission, e.g. an automatic transmission, or a manual transmission with mechanical and/or electric actuators. The vehicle can be a motor vehicle, a motor vehicle with automated driving, or a bus, rail vehicle, or aircraft. Depending on the design of the vehicle transmission, various gear settings or types of operation, e.g. park or neutral (idling), can be selected as the drive stages. The first and second axial wiping movements can be made with two fingers, for example, wherein each finger carries out one of the axial wiping movements. The first and second input regions can be two separate sensor surfaces, or two regions of a sensor surface with separate sensors, e.g. a sensor surface on a touch-sensitive screen. The first and second paths can be predefined paths over the respective input regions. The selected drive stage in that a predetermined matching of parameters of the first and second paths is established, e.g. in relation to a common length or a time interval in which the first and second wiping movements are carried out.

According to one embodiment, a length of the first path and a length of the second path for the selected drive stage can determine the selected drive stage in the output step. By way of example, a shifting from a first drive stage to a second drive stage, or from the first drive stage to a third or fourth drive stage, can be determined on the basis of the lengths of the first and second paths. Additionally or alternatively, a direction or axis of the first path and a direction or axis of the second path can determine the selected drive stage. For this, one drive stage can be determined in one direction, and another drive stage can be determined in another direction. The determination of the drive stages can also take place through the axes of the first path and the second path. Different drive stages can then be determined through differently oriented axes; e.g. the first axis of the first path and the second path can determine one drive stage, and a second axis, transverse to the first axis, can determine another drive stage. A starting point of the first path and a starting point of the second path, and/or the length, direction or axis, can determine the selected drive stage. Advantageously, a drive stage can be determined in a number of ways, making the method compatible with different commercially available vehicle transmissions.

In the output step, the shifting signal can be obtained on the basis of a distance threshold according to one embodiment. The distance threshold can represent a minimum length of the first and second paths. As a result, incorrect entries can be prevented, e.g. through a coincidental contact from a wiping movement, advantageously increasing the reliability in executing the method.

Furthermore, the shifting signal in the output step can be obtained according to one embodiment on the basis of an evaluation of an angle between the first axial wiping movement and the second axial wiping movement. The shifting signal can then be obtained when the angle lies within a predefined tolerance range, e.g. when the angle is no greater than a specific value. The predetermined tolerance range can lie, e.g. between −20° and 20°. The evaluation of the angle increases the reliability of the method with regard to possible unintentional incorrect entries.

In the output step according to one embodiment, it is also possible to check whether the first path passes over a first subregion in the first input region, assigned to a first drive stage and a second subregion assigned in the first input region, to a second drive stage, and whether the second path passes over a first section in the second input region, assigned to the first drive stage, and a second section in the second input region, assigned to the second drive stage. In this case, the shifting signal can be obtained if the first path passes over the first subregion and the second subregion, and the second path passes over the first section and the second section. By checking the paths, the wiping movements can be quickly and reliably assigned to the selected drive stage.

When it is checked in the output step whether the first path passes over the first and second subregions and the second path passes over the first and second sections, the first drive stage can be determined to be the selected drive stage in the output step if the first path ends in the first subregion and the second path ends in the first section, according to one embodiment. Alternatively or additionally, the second drive stage can be determined to be the selected drive stage if the first path ends in the second subregion and the second path ends in the second section. This advantageously increases user friendliness for a user, and therefore the input reliability, in particular if a division of the paths into the subregions and the sections is clear to the user, e.g. through a tactile or visible marking of the division.

In the output step according to one embodiment, it is also possible to check whether the first path passes over a third subregion of the first input region assigned to a third drive stage, which is located between the first subregion and the second subregion, and whether the second path passes over a third section of the second input region assigned to a third drive stage, which is located between the first section and the second section. The shifting signal can then be obtained if the first path passes over the first subregion, second subregion and third subregion, and the second path passes over the first section, second section, and third section.

The method according to one embodiment can also contain a step for detecting the first axial wiping movement over the first subregion and the second subregion, in order to obtain the first input signal. Furthermore, the second axial wiping movement over the first section and second section can be detected in the detecting step in order to obtain the second input signal. In this case, a tactile confirmation signal can be output along the first path, or at a point in the first path, as soon as the first axial wiping movement reaches one of the subregions in the first input region. Additionally or alternatively, the tactile confirmation signal can be output along the second path or at a point in the second path, as soon as the second axial wiping movement reaches one of the sections of the second input region. The confirmation signal can also be output at a transition between the subregions and/or the sections. A user can thus be advantageously notified of the possibility of selecting a drive stage upon reaching the subregion and section by the tactile confirmation signal, thus increasing user friendliness and enabling operation without looking, which is advantageous with regard to the reliability of the method when used while driving a vehicle.

There is also a sensor device for detecting a selection of a drive stage in a vehicle transmission in this approach. The sensor device comprises a first input region with a first subregion and a second subregion, separated from the first subregion by a tactile texture. The sensor device also comprises a second input region with a first subregion and a second subregion, separated from the first subregion by a tactile texture. The sensor device is configured to detect a first axial wiping movement over the first input region, and create a first input signal, representing the first axial wiping movement. The sensor device is also configured to detect a second wiping movement over the second input region, and create a second input signal, representing the second axial wiping movement.

There is also a control unit, which is configured to carry out the steps in the method described above in corresponding units, and/or control these units. The control unit can be an electric device that processes electric signals, e.g. sensor signals, and outputs control signals on the basis thereof. The control unit can contain one or more hardware and/or software interfaces. Hardware interfaces can be part of an integrated circuit, for example, in which functions of the control unit are implemented. These interfaces can also be individual integrated circuits, or composed at least in part of discrete components. Software interfaces can be software modules on a microcontroller, in addition to other software modules.

A computer program containing programming code that can be stored on a machine-readable medium, e.g. a solid state drive, hard drive, or optical memory, and used for executing the method according to any of the embodiments described above when the program is executed on a computer or control unit, is also advantageous.

Certain embodiments shall now be explained in greater detail by way of example, in reference to the attached drawings.

In the following description of preferred exemplary embodiments, the same or similar reference symbols are used for similar elements shown in the various figures, wherein there shall be no repetition of the descriptions of these elements.

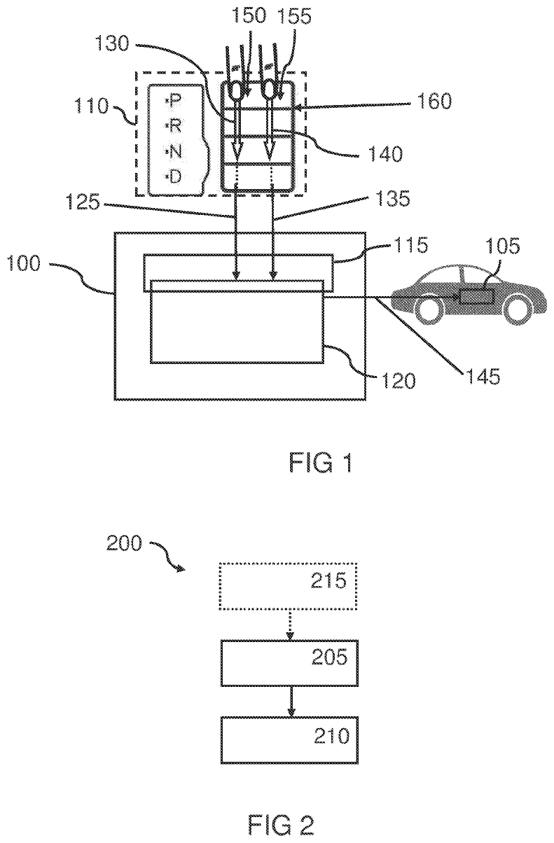

FIG. 1 shows a schematic illustration of a control unit 100 for setting a drive stage in a vehicle transmission 105. It also shows a sensor device 110 for detecting a selection of a drive stage in the vehicle transmission 105 according to an exemplary embodiment, which is connected for signal transfer to the control unit 100. The control unit 100 comprises an input device 115 and an output device 120. The input device 115 is configured to input a first input signal 125. The first input signal 125 represents an axial wiping movement 130 over a first input region. The input device 115 is also configured to input a second input signal 135. The second input signal 135 represents a second axial wiping movement 140 over a second input region, parallel to the first axial wiping movement 130. The first wiping movement 130 and the second wiping movement 140 are at least partially simultaneous. The output device 120 is configured to output a shifting signal 145 for setting a selected drive stage, based the first input signal 125 and the second input signal 135. A first path of the first axial wiping movement 130 and a second path of the second axial wiping movement 140 collectively determine the selected drive stage. The shifting signal 145 is then sent to the vehicle transmission 105.

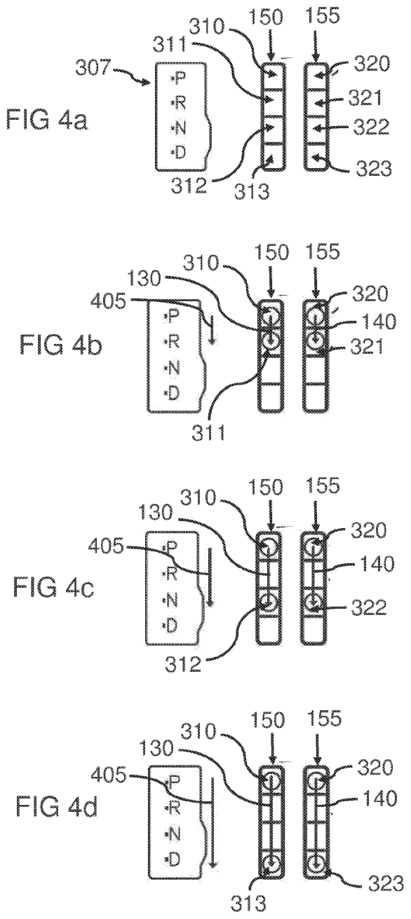

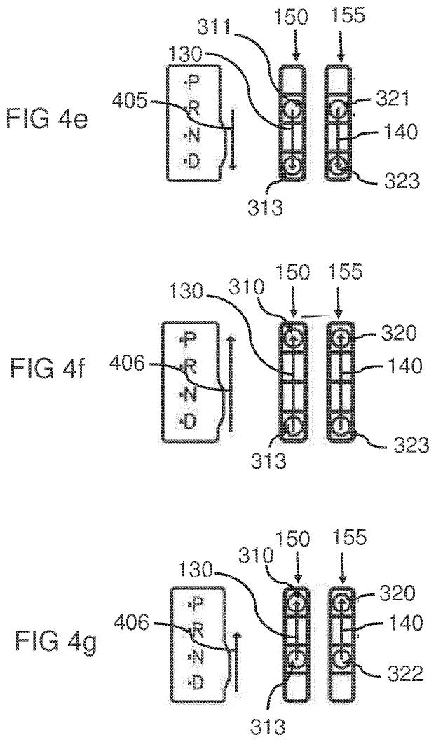

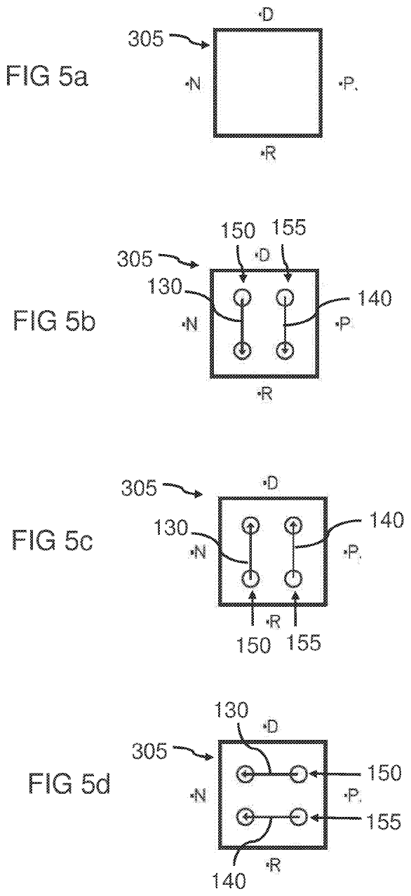

According to one exemplary embodiment, a length of the first path and a length of the second path determine the selected drive stage. Additionally or alternatively, a direction or axis of the first path and a direction or axis of the second path determine the selected drive stage. The selected drive stage can also be determined on the basis of a starting point for the first path and a starting point for the second path, as shown below in reference to FIGS. 4a to 4g. The shifting signal 145, and therefore the determination of the selected drive stage, is obtained with the first input signal 125, the second input signal 135, and a predefined comparison guideline, which comprises one or more of the parameters that are to be determined, such as the length, direction or axis, or the starting points of the paths. The selected drive stages are assigned to the corresponding parameters based on a reference table containing the predefined comparison guidelines. By way of example, a comparatively short path is used to select a different drive stage than a comparatively long path. This is explained in detail below, in reference to FIGS. 3a to 3d and 4a to 4g. Alternatively, the courses of the axes of the first and second paths determine the selected drive stage, as explained below in reference to FIGS. 5a to 5d.

The shifting signal 145 is also determined on the basis of a distance threshold according to one exemplary embodiment. The distance threshold represents a minimum length of the first path and the second path. This advantageously increases the input reliability with respect to incorrect inputs through unintentionally touching the first and second input regions.

The shifting signal 145 is also output according to one exemplary embodiment in the basis of an evaluation of an angle between the first axial wiping movement 130 and the second axial wiping movement 140. The shifting signal 145 is output in particular when the angle lies within a predefined tolerance range, e.g. between 0% and 20%.

The first input signal 125, and the second input signal 135, are obtained from the sensor device 110. The sensor device 110 comprises a first input region 150 and a second input region 155. The first input region 140 and the second input region 150 are shown herein, by way of example, as two adjacent regions, without a recognizable separation. The first axial wiping movement 130 passes over the first input region 150, and the second axial wiping movement 140 passes over the second input region 155. The first input region 150 contains a first subregion and a second subregion, separated from the first subregion by a tactile texture 160, and the second input region 155 contains a first section and a second section, separated from the first section by a tactile structure. The subregions and sections are each assigned a selectable drive stage P, R, N, D in the vehicle transmission, wherein the drive stages P, R, N, D of an automatic transmission are shown herein, by way of example. The sensor device 110 is also configured to detect the first wiping movement 130 over the first input region 150, and create the first input signal 125, representing the first wiping movement 130, and to detect the second axial wiping movement 140 over the second input region 155, and create the second input signal 135, representing the second wiping movement 140.

The first wiping movement 130 and the second wiping movement 140 are input by means of two fingers, for example, each of which passes over one of the two paths on the input regions 150, 155. A shifting from one of the drive stages P, R, N, D to another can then be detected through the lengths of the wiping movements 130, 140 by coupling positions on the path with the drive stages P, R, N, D. If the wiping movements 130, 140 are comparatively short, for example, the shifting will only be one position in the transmission. If the distance is longer, the shifting depends on the length of the path. This is described below in greater detail in reference to FIGS. 3a to 3d and 4a to 4g. To obtain a clear input and eliminate incorrect inputs, the shifting actuation is input via the first wiping movement 130 and the second wiping movement 140 together, e.g. by means of two fingers. The shifting signal 145 is only output when both fingers execute the axial wiping movements 130, 140 simultaneously. The axes of the wiping movements 130, 140 mirror the axes of the shifting positions for the transmission, and therefore the drive stages P, R, N, D. The gear settings or drive stages P, R, N, D are shifted within these axes based on the lengths of the wiping movements 130, 140. Optionally, the individual positions are determined with tactile feedback, such as the tactile texture 160.

According to one exemplary embodiment, the control unit 100 is configured to detect the first axial wiping movement 130 over the first subregion and the second subregion to obtain the first input signal 125. The control unit is also configured to detect the second axial wiping movement 140 over the first section and second section to obtain the second input signal 135. A tactile confirmation signal is output along the first path as soon as the first axial wiping movement 130 reaches one of the subregions in the first input region 150. Additionally or alternatively, the tactile confirmation signal is output along the second path as soon as the second axial wiping movement 140 reaches one of the sections in the second input region 155. According to the exemplary embodiment shown herein, the sensor device 110 is configured to detect the first wiping movement 130 and the second wiping movement 140, and create the first input signal 125 and the second input signal 135. The sensor device 110 can also be configured to output the tactile confirmation signal. The tactile confirmation signal can be generated with a vibrator motor or a “force feedback actuator,” e.g. a piezo element. In addition to, or alternatively to the tactile confirmation signal, an acoustic and/or visual signal can also be generated, indicating a drive stage selection or the reaching of one of the subregions or one of the sections.

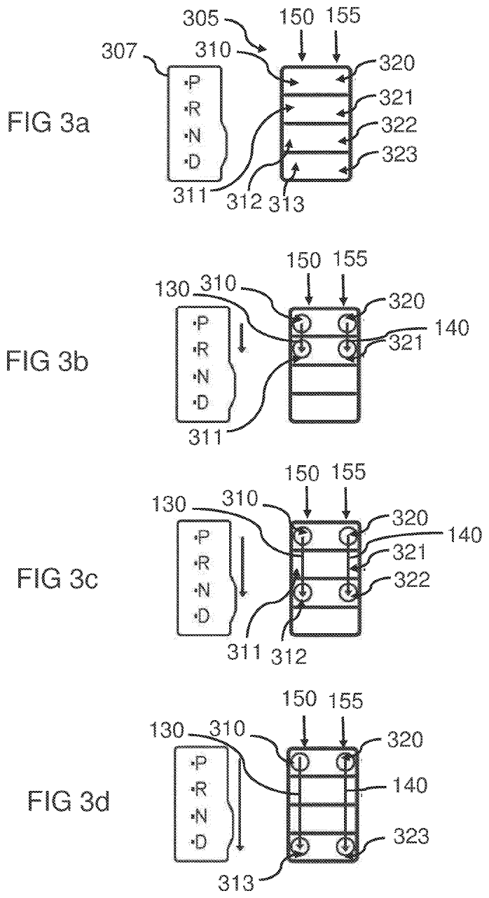

FIG. 2 shows a flow chart for a method 200 for setting a drive stage in a vehicle transmission according to an exemplary embodiment. The method 200 can be executed by the control unit described above. The method 200 comprises at least one input step 205 and one output step 210. The first input signal and the second input signal are input in the input step 205. The first input signal represents a first axial wiping movement over a first input region. The second input signal represents a second axial wiping movement over a second input region, parallel to the first axial wiping movement. The first wiping movement and the second wiping movement are at least partially simultaneous. A shifting signal for setting a selected drive stage is output in the output step 210 based on the first input signal and the second input signal. A first path of the first axial wiping movement and a second path of the second axial wiping movement then determine the selected drive stage.

According to the exemplary embodiment shown herein, the method 200 also comprises an optional detection step 215. The detection step can be executed before the input step, e.g. using an exemplary embodiment of the control unit, or using the sensor device described above. The first axial wiping movement over a first subregion and a second subregion of the first input region is detected in the detection step 215 to obtain the first input signal. The second axial wiping movement over a first section and a second section of the second input region is also detected in the detection step 215 to obtain the second input signal. Furthermore, a tactile confirmation signal is output in the detection step 215 on the first path as soon as the first axial wiping movement reaches one of the subregions in the first input region. Additionally or alternatively, the tactile confirmation signal is output along the second path in the detection step 215 as soon as the second axial wiping movement reaches one of the sections in the second input region.

FIGS. 3a to 3d each show a schematic illustration of drive stage assignments P, R, N, D to input regions 150, 155 for setting one of the drive stages P, R, N, D in a vehicle transmission, for use in an exemplary embodiment of the approach presented herein. Exemplary operating patterns for transmission control by means of the first and second wiping movements over a touch-sensitive surface 305 are shown in FIGS. 3b to 3d. The touch-sensitive surface 305 comprises the first input region 150 and the second input region 155, also shown here by way of example as adjacent regions without a recognizable separation. The touch-sensitive surface 305 can also have a recessed finger pathway in both the first input region 150 and the second input region 155, which guides the axial wiping movement. The touch-sensitive surface 305 can be formed by a surface that can be assessed by means of capacitive or resistive sensors. A display 307 of the selectable drive stages P, R, N, D for the transmission settings is also shown.

To shift the vehicle transmission via the touch-sensitive surface 305, a simple and intuitive operation, clear reliable signals, and protection against incorrect inputs are advantageous. This is achieved here with two input regions 150, 155, and by the two-finger input by means of the parallel wiping movements executed simultaneously, within a tolerance range.

The first input region 150 also contains four subregions 310, 311, 312, 313: a first subregion 310, assigned by way of example to the drive stage P, a second subregion 311, assigned by way of example to the drive stage R, a third subregion 312, assigned by way of example to the drive stage N and a fourth subregion 313, assigned by way of example to the drive stage D. The second input region contains, by way of example, four sections 320, 321, 322, 323: a first section 320, assigned by way of example to the drive stage P, a second section 321, assigned by way of example to the drive stage R, a third section 322, assigned by way of example to the drive stage N, and a fourth section 323, assigned by way of example to the drive stage D. The subregions 310, 311, 312, 313 and the sections 320, 321, 322, 323 are only all provided with reference symbols in FIG. 3a, by way of example for FIGS. 3a to 3d. Optionally, the subregions 310, 311, 312, 313 and the sections 320, 321, 322, 323 are each separated from one another by the tactile textures, e.g. in the form of ribbing, which provide the user with tactile feedback during the wiping movement when one of the regions assigned to the drive stages P, R, N, D is reached. As an alternative to tactile textures, reaching one of the subregions 310, 311, 312, 313 or one of the sections 320, 321, 322, 323 can also be indicated by the tactile signal described in greater detail in reference to FIG. 1.

FIG. 3a shows the first input region 150 and the second input region 155 on the touch-sensitive surface 305, and the division of the first input region 150 into the four subregions 310, 311, 312, 313, and the second input region 155 into the fourth sections 320, 321, 322, 323, with the aforementioned assignments to the drive stages P, R, N, D that can be selected. This arrangement is exemplary for the operating patterns for the first and second axial wiping movements described in reference to FIGS. 3b to 3d.

FIG. 3b shows the first wiping movement 130, from the first subregion 310 to the second subregion 311, and the second wiping movement 140, from the first section 320 to the second section 321. To obtain the shifting signal, it is first checked according to one exemplary embodiment, whether the first path passes over a first subregion 310, assigned to a first drive stage P, by way of example, and a second subregion 311, assigned to the second drive stage R, in the first input region 150, and whether the second path passes over a first section 320 assigned to the first drive stage P and a second section 321 assigned to the second drive stage R, in the second input region 155. If this is the case, as in the exemplary embodiment shown herein, the shifting signal is created. A comparatively short axial wiping movement, in the form of the first wiping movement 130 and the second wiping movement 140, is executed here for the first path and second path, by means of which the shifting setting is changed in the respective direction, from P to R here, based on the shifting signal.

According to one exemplary embodiment, the first drive stage, by way of example P, is determined to be the selected drive stage if the first path ends in the first subregion 310 and the second path ends in the first section 320. This is not the case here. The second drive stage R is determined to be the selected drive stage if the first path ends in the second subregion 311 and the second path ends in the second section 321. Accordingly, the drive stage R is determined to be the selected drive stage according to the exemplary embodiment shown here.

FIG. 3c shows the first wiping movement 130, passing here from the first subregion 310, over the second subregion 311, to the third subregion 312, and the second wiping movement 140, passing from the first section 320, over the second section 321, to the third section 322. This is therefore a comparatively medium length axial wiping movement in the form of the first wiping movement 130 and the second wiping movement 140, which enables a shifting of two shift positions in the direction of the wiping movements 130, 140, and therefore a shifting from the drive stage P to the drive stage N. In accordance with the paths of the first wiping movement 130 and the second wiping movement 140, it is determined that the drive stage N is the selected drive stage. According to one exemplary embodiment, it is checked when outputting the shifting signal, whether the first path passes directly from one of the subregions 310, 311, 312 to the subregion where the path ends, or whether it passes over another subregion that lies between the subregion where the path begins, subregion 310 here, and the subregion where the path ends, subregion 312 here. This is also checked in the same manner for the second path over the sections 320, 321, 322, 323.

FIG. 3d shows the first wiping movement 130 and the second wiping movement 140 as comparatively long axial wiping movements, enabling shifting of three shifting positions in the direction of the wiping movements 130, 140 shown here, and therefore a shifting from the drive stage P to the drive stage D. The first wiping movement 130 passes from the first subregion 310, over the second and third subregions, to the fourth subregion 313, assigned to the drive stage D, and the second wiping movement 140 passes from the first section 320, over the second and third sections, to the fourth section 323, assigned to the drive stage D.

FIGS. 4a to 4g each show a schematic illustration of an assignment of drive stages P, R, N, D to input regions 150, 155 for setting the drive stages P, R, N, D in a vehicle transmission for use in an embodiment of the approach presented herein. The first input region 150 and the second input region 155 are shown here, by way of example, as separate parallel touch-sensitive regions. As described in reference to FIG. 3, the first input region 150 also comprises the four subregions 310, 311, 312, 313, and the second input region contains the four sections 320, 321, 322, 323 here, each of which is assigned to one of the drive stages P, R, N, D. Only some of subregions 310, 311, 312, 313 and the sections 320, 321, 322, 323 have reference symbols in the individual FIGS. 4a to 4g, depending on the exemplary embodiment. The touch-sensitive regions in the input regions 150, 155 each have an optional recessed finger track here, for guiding the axial wiping movements 130, 140, and a ribbing between the subregions 310, 311, 312, 313 or sections 320, 321, 322, 323 for tactile feedback when executing the wiping movements 130, 140. The display 307 of the selectable drive stages P, R, N, D, corresponding to transmission settings is also shown.

FIG. 4a shows the division of the first input region 150 into the four subregions 310, 311, 312, 313 and the second region 155 into the four sections 320, 321, 322, 323 with the specified assignments to the displayed, selectable drive stages P, R, N, D.

FIG. 4b shows the first wiping movement 130, passing from the first subregion 310 to the second subregion 311, and the second wiping movement 140, passing from the first section 320 to the second section 321. By means of the wiping movements 130, 140 shown here, it is possible to change the drive stage one position in the direction indicated by the orientation of the arrow 405, and in which the wiping movements 130, 140 are executed. If the drive stage P has been set, the drive stage R is selected with the input shown here, if the drive stage R has been set, the drive stage N is selected with the input shown here, and if the drive stage N has been selected, the drive stage D is selected with the input shown here. According to the exemplary embodiment shown here, the selected drive stage P, R, N, D is determined based on the length and direction of the wiping movements 130, 140.

FIG. 4c shows the first wiping movement 130, passing from the second subregion 311 to the fourth subregion 313, and the second wiping movement 140, passing from the second section 321 to the fourth section 323. The input shown here corresponds to a change in the drive stage P, R, N, D of two positions in the direction of the wiping movements 130, 140, also indicated here by the orientation of the arrow 405. The drive stage N is then selected with the input shown here in the form of the medium length wiping movements 130, 140, if the drive stage P has been selected, and the drive stage D is selected if the drive stage R has been set.

FIG. 4d shows the first wiping movement 130, passing from the first subregion 310 to the fourth subregion 313 here, and the second wiping movement 140, passing from the first section 320 to the fourth section 323. The input shown here corresponds to a change in the drive stage P, R, N, D of three positions in the direction of the wiping movements 130, 140, indicated here by the orientation of the arrow 405, such that the drive stage D is selected with the long axial wiping movements 130, 140 shown here, when the drive stage P has been set.

FIG. 4e shows the first wiping movement 130, passing from the second subregion 311 to the fourth subregion 313, and the second wiping movement 140, passing from the second section 321 to the fourth section 323. The input shown here corresponds to a change in the drive stage P, R, N, D of two positions in the direction of the wiping movements 130, 140, indicated here by the orientation of the arrow 405. The drive stage N is then selected with the input shown here in the form of the medium length wiping movements 130, 140, if the drive stage P has been selected, and the drive stage D is selected if the drive stage R has been set, as is the case in the exemplary embodiment shown in FIG. 4c.

FIG. 4f shows the first wiping movement 130, passing from the fourth subregion 313 to the first subregion 310 here, and the second wiping movement 140, passing from the fourth section 323 to the first section 320. A change in the drive stage P, R, N, D of three positions is input here in the direction of the wiping movements 130, 140, corresponding to the indicated orientation of the other arrow 406, such that the drive stage P is selected when the drive stage D has been set.

FIG. 4g shows the first wiping movement 130, passing from the third subregion 312 to the first subregion 310 here, and the second wiping movement 140, passing from the third section 322 to the first section 320. A change in the drive stage P, R, N, D of two positions in the direction of the wiping movements 130, 140 is input here, corresponding to the indicated orientation of the other arrow 406, such that the drive stage R is selected if the drive stage D has been set, and the drive stage P is selected if the drive stage N has been set.

FIGS. 5a to 5d each show a schematic illustration of an assignment of drive stages P, R, N, D to input regions 150, 155 for setting a drive stage in a vehicle transmission for use in an exemplary embodiment of the approach presented herein. In the exemplary embodiments shown here, the first input region 150 and the second input region 155 are defined by the axes of the first and second wiping movements 130, 140. The drive stages P, R, N, D are displayed around the touch-sensitive surface 305. The touch-sensitive surface 305 forms a dual input region for the first input region 150 and the second input region 155. The first wiping movement 130 and the second wiping movement 140 can be executed in different directions or axes. As an alternative to the operating principle shown here, in which the axes and directions of the first wiping movement 130 and second wiping movement 140 define the selection of the drive stage, it is also possible to enable only two directions for the wiping movements 130, 140 on the touch-sensitive surface 305. In this case, forward wiping results in setting the drive stage D, and rearward wiping results in setting the drive stage R. In this case, selection of the drive stages P and N can only take place via buttons.

FIG. 5a shows the touch-sensitive surface 305, in the form of a square here. Each side of the square touch-sensitive surface 305 is assigned to one of the drive stages P, R, N, D.

FIG. 5b shows the first wiping movement 130 and the second wiping movement 140, which run along a vertical axis from a side of the touch-sensitive surface assigned to the drive stage D toward a side of the touch-sensitive surface 305 assigned to the drive stage R. The first path of the first wiping movement 130 defines the first input region 150, and the second path of the second wiping movement 140 defines the second input region 155. The drive stage R is therefore selected by means of the input shown here.

FIG. 5c shows the first wiping movement 130 and the second wiping movement 140, which run along a vertical axis from the side of the touch-sensitive surface 305 assigned to the drive stage R toward the side of the touch-sensitive surface 305 assigned to the drive stage D. The first path of the first wiping movement 130 defines the first input region 150, and the second path of the second wiping movement 140 defines the second input region 155. The drive stage D is therefore selected by means of the input shown here.

FIG. 5d shows the first wiping movement 130 and the second wiping movement 140, which run along a horizontal axis from a side of the touch-sensitive surface 305 assigned to the drive stage P toward a side of the touch-sensitive surface 305 assigned to the drive stage N. The first path of the first wiping movement 130 defines the first input region, and the second path of the second wiping movement 140 defines the second input region. The drive stage N is therefore selected by means of the input shown here.

The exemplary embodiments described herein and shown in the figures are selected merely by way of example. Different exemplary embodiments can be combined with one another, either entirely or with respect to individual features. An exemplary embodiment can also be supplemented by features of another exemplary embodiment.

Furthermore, method steps can be repeated, as well as executed in a sequence other than that described herein.

If an exemplary embodiment comprises an “and/or” conjunction between a first feature and a second feature, this can be read to mean that the exemplary embodiment according to one embodiment contains both the first feature and the second feature, and contains either just the first feature or just the second feature according to another embodiment.

### REFERENCE SYMBOLS

100 control unit
105 vehicle transmission
110 sensor device
115 input device
120 output device
125 first input signal
130 first wiping movement
135 second input signal
140 second wiping movement
145 shifting signal
150 first input region
155 second input region
160 tactile texture
P, R, N, D drive stages
200 method
205 input step
210 output step
215 detection step
305 touch-sensitive surface
307 transmission setting display
310 first subregion
311 second subregion
312 third subregion
313 fourth subregion
320 first section
321 second section
322 third section
323 fourth section
405 arrow
406 second arrow

1. A method for setting a drive stage in a vehicle transmission, the method comprising:
inputting a first input signal that represents a first wiping movement over a first input region;
inputting a second input signal that represents a second movement over a second input region, the second axial movement being parallel to the first axial wiping movement, wherein the first wiping movement and the second wiping movement are at least partially simultaneous; and
outputting a shifting signal for setting a selected drive stage based on the first input signal and the second input signal, wherein a first path of the first axial wiping movement and a second path of the second axial wiping movement determine the selected drive stage.

2. The method according to claim 1, wherein a length of the first path and a length of the second path determine the selected drive stage, and/or a direction or axis of the first path and a direction or axis of the second path determine the selected drive stage, and/or a starting point of the first path and a starting point of the second path determine the selected drive stage.

3. The method according to claim 1, wherein in the output step, the shifting signal is output on the basis of a distance threshold, wherein the distance threshold represents a minimum length of the first path and the second path.

4. The method according to claim 1, wherein, in the output step, the shifting signal is output on the basis of an evaluation of an angle between the first axial wiping movement and the second axial wiping movement, in particular wherein the shifting signal is then created when the angle lies within a predetermined tolerance range.

5. The method according to claim 1, wherein, in the output step, it is checked whether the first path passes over a first subregion of the first input region, assigned to a first drive stage and a second subregion, and a second subregion of the first input region, assigned to a second drive stage, and whether the second path passes over a first section of the second input region, assigned to the first drive stage and a second section of the second input region, assigned to the drive stage, wherein the shifting signal is obtained if the first path passes over the first subregion and the second subregion, and the second path passes over the first section and the second section.

6. The method according to claim 5, wherein, in the output step, the first drive stage is determined to be the selected drive stage if the first path ends in the first subregion and the second path ends in the first section, and/or the second drive stage is determined to be the selected drive stage if the first path ends in the second subregion and the second path ends in the second section.

7. The method according to claim 5, wherein, in the output step, it is checked whether the first path passes over a third subregion of the first input region, assigned to a third drive stage, which is located between the first subregion and the second subregion, and whether the second path passes over a third section of the second input region, assigned to a third drive stage, which is located between the first section and the second section, wherein the shifting signal is then obtained when the first path passes over the first subregion, the second subregion and the third subregion, and the second path passes over the first section, the second section and the third section.

8. The method according to claim 5, further comprising detecting the first axial wiping movement over the first subregion and the second subregion, to obtain the first input signal, and the second axial wiping movement over the first section and the second section, to obtain the second input signal, wherein a tactile confirmation signal is output along the first path, or at a point on the first path, as soon as the first axial wiping movement reaches one of the subregions in the first input region, and/or wherein a tactile confirmation signal is output along the second path, or at a point in the second path, as soon as the second axial wiping movement reaches one of the sections in the second input region.

9. A sensor device for detecting a selection of a drive stage in a vehicle transmission, wherein the sensor device comprising:
a first input region that has a first subregion and a second subregion, the second subregion being separated from the first subregion by a tactile texture; and
a second input region that has a first section and a second section, the second section being separated from the first section by a second tactile texture,
wherein the sensor device is configured to detect a first axial wiping movement over the first input region,
wherein the sensor device is configured to create a first input signal, representing the first wiping movement,
wherein the sensor device is configured to detect a second axial wiping movement over the second input region, and
wherein the sensor device is configured to create a second input signal, representing the second wiping movement.

10. A control unit that is configured to execute the steps of the method according to claim 1.

11. A computer program that is configured to execute the method according to claim 1.

12. A machine-readable storage medium on which the computer program according to claim 11 is stored.

13. The method according to claim 1, wherein at least one of a direction and an axis of the first path and at least one of a direction and an axis of the second path determine the selected drive stage.

14. The method according to claim 1, wherein a starting point of the first path and a starting point of the second path determine the selected drive stage.
